(19) United States
(12) Patent Application Publication
(10) Pub. No.: US 2011/0052190 A1
(43) Pub. Date: Mar. 3, 2011

(54) Discovery of an Adjacent Network Element within a Network Data Plane

(76) Inventors: Biao Lu, Cupertino, CA (US); Mohit Misra, Bangalore (IN); Maneesh Jain, Bangalore (IN); Shankara Ramamurthy, Chennai (IN)

(21) Appl. No.: 11/851,339

(22) Filed: Sep. 6, 2007

(51) Int. Cl. H04J 14/00

(52) U.S. Cl. 398/43

(57) ABSTRACT

The present invention provides a system, apparatus and method for discovery of network elements, which are adjacent within the network data plane but may or may not be adjacent in the network control plane. In one embodiment of the present invention, digital network elements, with a plurality thereof having a lambda switching capability (hereinafter “LSC”) interface, is provided. A digital network element with an LSC interface originates and sends a local advertisement to its immediate control neighbor. Using this LSC originated advertisements; a neighboring network element may be discovered that is adjacent on the network data plane.

### CROSS REFERENCE TO RELATED PATENT APPLICATIONS

This application claims priority to U.S. Provisional Application Ser. No. 60/695,392, entitled “Technique for Data-Plane-Adjacent Neighbor Discovery for Network Element (NEs) that are not Control-Plane-Adjacent,” filed Jun. 30, 2005, which application is incorporated herein by reference in its entirety.

### BACKGROUND

A. Technical Field

The present invention relates generally to optical communication network systems, and more particularly, to the discovery of network neighbors that are not physically adjacent to each other within an optical communication system.

B. Background of the Invention

In an optical communication network system, various network elements or other network nodes are connected to each other for carrying traffic from one end to another end. There may be two types of network elements in the network namely digital nodes and optical nodes. Each of the digital nodes has Lambda (wavelength) switching capability that enables a digital node to switch lambda from one port to any other port depending on how the traffic is required to be forwarded in the network. Optical nodes on the other hand are not able to switch lambda and are merely used to transfer wavelength from one port to another after its amplification.

The location of nodes, for example digital nodes, may vary within a network. Digital nodes may be connected directly or there can be one or more optical amplifiers between them. Even when two digital nodes are not physically adjacent they may behave like virtually adjacent neighbors (referred to as “virtual digital neighbors”) in order to exchange certain kind of information. It is an essential requirement within an optical network that these digital nodes identify their virtual neighbors when they are not physically adjacent.

Typically, network neighbors (whether digital or optical) are discovered by using a “HELLO” protocol 100 as shown in FIG. 1 and which is commonly known within the art. This protocol is responsible for establishing and maintaining neighbor relationships and ensuring bidirectional communication between all neighbors which are Digital NE 1 101, Digital NE 2 102 and Digital NE 3 103.

In this “Hello” protocol, ‘Hello’ packets are sent to all router interfaces at fixed intervals. When a router sees itself listed in its neighbor's “Hello” packet it establishes a bidirectional communication. An attempt is always made to establish adjacencies over point-to-point links so that the neighbors' topological databases may be synchronized.

However, the traffic engineering topology view of a generalized multi-protocol label-switching (“GMPLS”) network provides a data-plane connectivity view of the network, which is represented at an appropriate layer of switching/connectivity capability. The traffic engineering topology gives a view of only digital nodes and not optical amplifiers, thus it may differ from the physical topology of the network when the digital nodes are not physically adjacent and have optical amplifiers in between. In this scenario, HELLO protocol may not be efficient enough to locate the virtual neighbors.

Therefore, there is a need for a system, apparatus and method for providing discovery of neighboring network elements that are not adjacent within the network control plane.

### SUMMARY OF THE INVENTION

The present invention provides a system, apparatus and method for discovery of network elements, which are adjacent within the network data plane but may or may not be adjacent in the network control plane. In one embodiment of the present invention, digital network elements, with a plurality thereof having a lambda switching capability (hereinafter “LSC”) interface, is provided. Each digital network element, with a LSC interface, originates and sends a local advertisement to its immediate control neighbor. In one embodiment, the immediate control neighbor may be another digital network element, with an LSC interface, that receives the local advertisement and respond with an advertisement of its own for that interface. In another embodiment, the immediate control neighbor is a lower-layer element, such as an optical amplifier(s), that effectively forwards the advertisement to the next control neighbor. Using these LSC originated advertisements; a neighboring network element may be discovered that is adjacent on the network data plane.

In various embodiments of the invention, the immediate neighboring network element may be an optical network element that receives the local advertisement and forwards the local advertisement to a next immediate control neighbor. If the immediate control neighbor of the optical network element is a digital network element, the digital network element may respond with an advertisement of its own resulting in the data plane-adjacent neighbor being discovered.

In various embodiments of the invention, a chain of more than one optical network element between any two digital network elements with LSC interfaces may exist. In such cases, a series of local advertisements may be originated and forwarded in the chain until the next network element with an LSC interface or the data-plane-adjacent neighbor is discovered. This discovery would occur when a response message is received at the originating LSC interface.

The digital network element with an LSC interface multiplexes or de-multiplexes traffic at a transmitting or receiving end. The traffic may be sent and received on an optical channel group having a collection of ‘N’ number of wavelengths. Further, a local advertisement may be sent and received on a separate control link such as optical servicing channel. The local advertisement may be defined as a link opaque link state advertisement or “link opaque LSA.”

In another embodiment of the invention, an optical network system having a neighbor discovery technique is provided. The optical network system may be an optical long-haul network system that comprises a plurality of communicatively coupled digital network elements, each having a “LSC” interface that sends a local advertisement to its immediate control neighbor. The digital network elements may be connected to one or more optical network elements that receive the local advertisement and forward the same to a next immediate control neighbor.

The optical network system may further comprise an optical channel group that carries traffic to the digital and optical network elements. A control channel is also provided in the system that builds point-to-point links between any two immediate control neighbors. This control channel may be used so that a neighboring network element, other than an immediate control neighbor, is discovered when a digital network element with an LSC sends a local advertisement to its immediate control neighbor, and receives a response with an advertisement of another digital network element with LSC.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a prior art approach for discovery of network neighbor elements that are control plane adjacent.

FIG. 2 illustrates a general method for discovery of neighboring network elements in the data plane of a network according to one embodiment of the invention.

FIG. 3 illustrates data-plane neighboring network element discovery according to one embodiment of the invention

FIG. 4 illustrates data-plane neighboring network element discovery according to another embodiment of the invention

FIG. 5 illustrates data-plane neighboring network element discovery according to another embodiment of the invention.

FIG. 6 illustrates data-plane neighboring network element discovery with node C as OADM node.

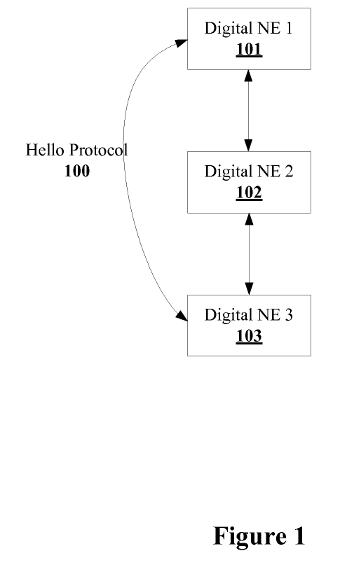

### DETAILED DESCRIPTION OF THE PREFERRED EMBODIMENTS

A system, apparatus and a method are described for discovery of network elements, which are adjacent within a network data plane but not adjacent in the network control plane.

The following description is set forth for purpose of explanation in order to provide an understanding of the invention. However, it is apparent that one skilled in the art will recognize that embodiments of the present invention, some of which are described below, may be incorporated into a number of different computing systems and devices. The embodiments of the present invention may be present in hardware, software or firmware. Structures and devices shown below in block diagram are illustrative of exemplary embodiments of the invention and are meant to avoid obscuring the invention. Furthermore, connections between components within the figures are not intended to be limited to direct connections. Rather, data between these components may be modified, re-formatted or otherwise changed by intermediary components.

Reference in the specification to “one embodiment”, “in one embodiment” or “an embodiment” etc. means that a particular feature, structure, characteristic, or function described in connection with the embodiment is included in at least one embodiment of the invention. The appearances of the phrase “in one embodiment” in various places in the specification are not necessarily all referring to the same embodiment.

A. Overview

The typical destinations for traffic messages coming from various customer sources are intended for digital network nodes and not optical nodes. If an optical node receives such traffic, it simply forwards the traffic to another node until a digital node is found so that the traffic may be processed accordingly. The digital nodes are configured to exchange control information between the nodes (optical and digital). These control messages may include local binding information that contains data about a local transmitter node or information about time slots that are allotted in the digital nodes for adding or dropping the traffic.

The time slots are defined in the hardware of the digital nodes for building cross connections. The cross connections communicate traffic coming from one port to another port using these different time slots. A large number of cross connects may be required at each node depending on the amount and type of traffic at the particular node(s). Traffic is typically communicated in separate time slots and the same time slots may be maintained on any two digital nodes when they are exchanging traffic. Once the traffic is dropped at a node, the allotted time slots associated with that dropped traffic become free. A free time slot can be used for sending other traffic or otherwise re-aligned.

The cross connects are typically configured when the node is initially installed and the connections within the cross connects may be defined during this configuration process or some time later. The cross connections in the digital nodes may be configured manually wherein each digital node is configured in terms of input/output port, or the time slots being used. The cross connections in the digital nodes may also be created automatically by sending messages to any node and for creating a circuit from the node to any other node.

This configuration effectively establishes the traffic route that is being used to communicate traffic. Depending on the characteristics and length of fiber used to connect two digital network elements, the signal path may also contain optical amplifiers or regenerators that enhance the signal along its path. These devices may be intermediary devices may be transparent on a network data plane but nevertheless be present on the network control plane. The discovery process for peer digital network elements is able to account for these optical, lower-layer nodes.

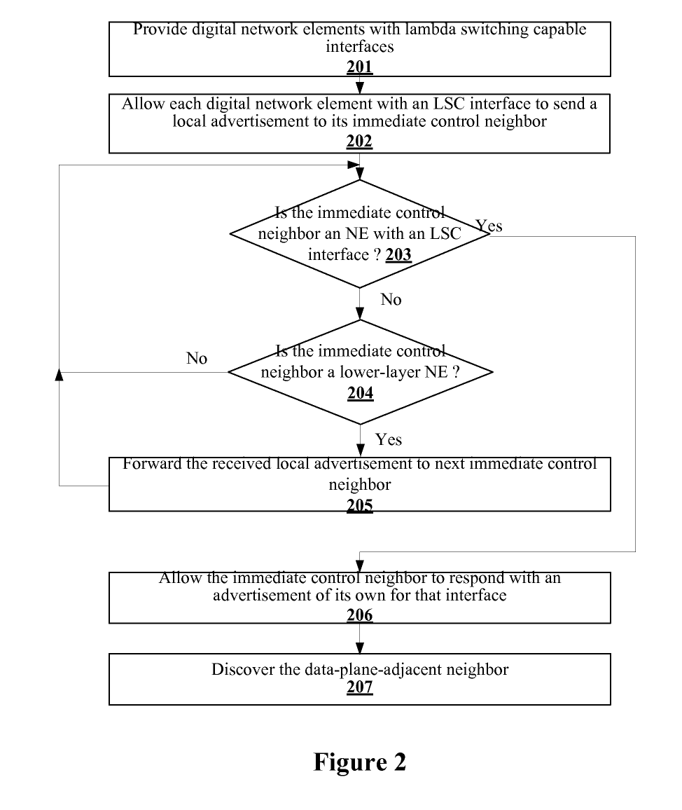

FIG. 2 illustrates a general method for discovery of a neighboring network element in a network data plane. The method may be initiated by providing digital network elements with LSC interfaces 201. Each of these network interfaces sends a local advertisement to its immediate control neighbor 202 on one or more optical service channels. If the receiver of this advertisement is a digital node 203, it discovers the digital neighbor by matching the received OCG types with ones it is supporting. If a match is found it responds by generating its own local advertisement towards the same control neighbor from where it received the advertisement 206. If no OCG types match then neighbor discovery is aborted and response is not sent.

If the recipient of local advertisement is a lower-layer network element (such as an optical amplifier), then the local advertisement that was received by the lower-layer network element is forwarded in its own link local advertisement towards its next immediate control neighbor 205. This forwarded advertisement may be transmitted on an optical supervisory channel or channels.

The step may then be repeated so if the next immediate control neighbor of the lower-layer network element is a digital network element, it may respond with an advertisement of its own 206, and the data-plane-adjacent neighbor is discovered 207. If there is a chain of more than one lower-layer network elements between two digital network elements with LSC interfaces, then a series of local advertisements (e.g., one per lower-layer network element) may be originated and forwarded in the chain until the next digital network element with an LSC interface is discovered. A response is provided from the receiving LSC interface and it is subsequently discovered by the originating LSC.

B. Discovery of Neighboring Network Elements within a Network Data Plane

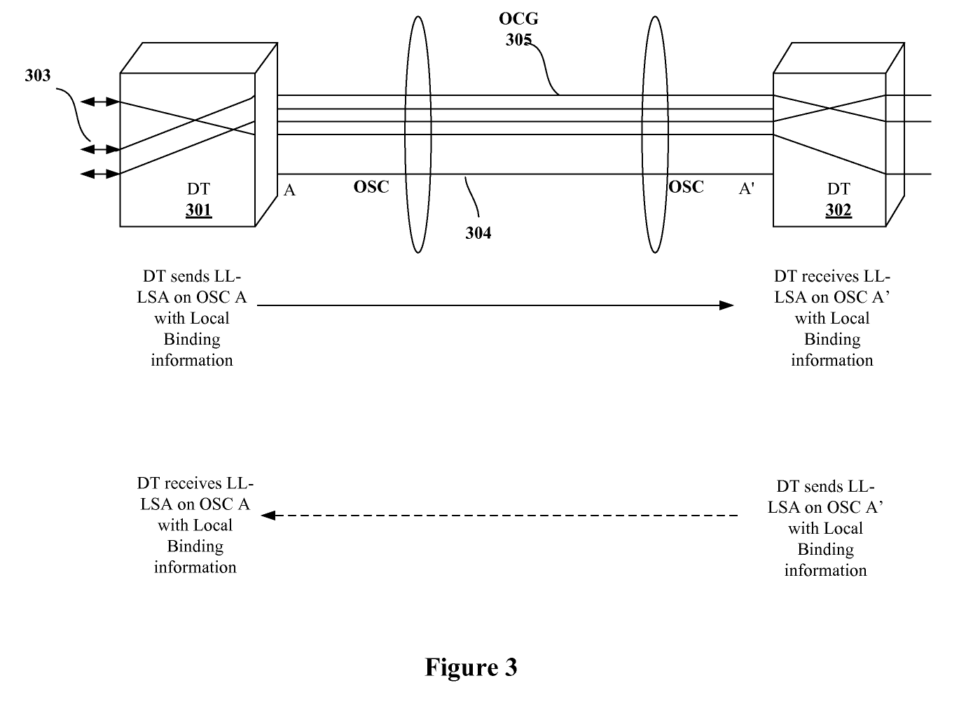

FIG. 3 structurally illustrates the discovery of a neighboring network element within a network data plane according to one embodiment of the invention. The present invention provides a plurality of digital nodes, within a network, with the ability to discover virtual data plane neighboring network elements. According to the embodiment shown in FIG. 3, two digital nodes may be directly connected by optical fiber. In this example, there is no intermediary optical amplifier which suggests that a signal is able to be communicated between the nodes without amplification or regeneration.

A first digital node or digital terminal (“DT”) 301 is connected to a second digital terminal (DT) 302. These digital terminals 301, 302 are configured using a management station in order to receive process and transfer traffic as well as communicate control signals. This configuration process includes providing each digital node 301, 302 with an LSC (Lambda Switching Capability) interface defining a number of cross connections and time slots to be associated with network traffic.

The first DT 301 receives and multiplexes traffic 303 coming from various customer sources over an optical fiber group (“OCG”) 305. Before sending the multiplexed traffic 303 to the destination, the first DT 301 needs to discover its destination or the data plane neighbor where the data traffic should be sent. The first DT 301, which has a configured LSC interface, sends a local advertisement, such as a local opaque link state advertisement, on optical service channel A to its immediate control neighbor, which is the second DT 302. If the second DT 302, also having an LSC interface, receives the advertisement, it responds on optical service channel A′ with an advertisement of its own for that interface. After reception of this response message, the first DT 301 discovers the second DT 302 as its data-plane-adjacent neighbor.

The multiplexed data traffic 303 may then be sent on the optical channel group 305. An optical channel group 305 is a collection of “N” wavelengths or lambdas that communicate network traffic between nodes. For example, if 10 wavelengths are carried on one optical channel group, then four optical channel groups would be equivalent to 40 wavelengths as shown in FIG. 3 as the “OCG” 305. The data traffic 303 would be transmitted on one or more of these 40 wavelengths between the first DT 301 and the second DT 302.

Comparatively, a local advertisement is sent on a separate optical servicing channel (OSC) 304. The OSC 304 is a control channel that is responsible for building point-to-point links A-A′ between control plane neighbors 301, 302. Typically, data traffic 303 is not communicated on these optical servicing channels, but control/service information such as local advertisement messages are reserved for these channels.

In one embodiment, a local advertisement contains the following information:
Number of OCGs carried in the physical link
Properties of each OCG such as advertising router ID, Interface Index, Band ID, OCG ID, AID, Channel usage for 10G or 2.5G bandwidth etc.

A response to a local advertisement is another local advertisement generated by the receiving node, which contains the similar information pertaining to its own side of link. Using this information, a communication link may be established between the first DT 301 and the second DT 302.

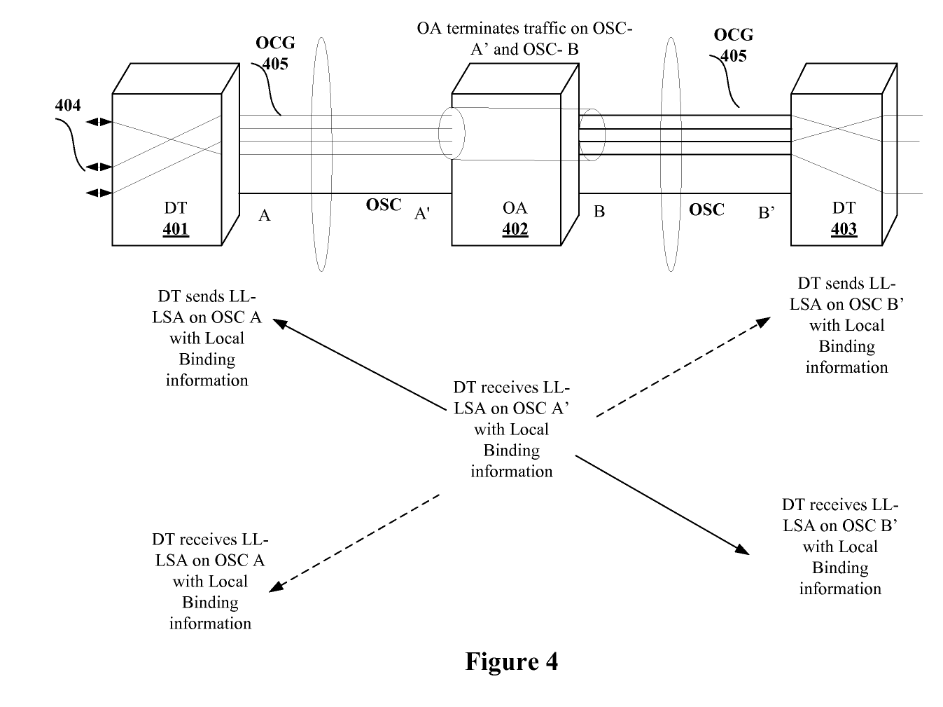

FIG. 4 illustrates the discovery of digital network elements that are adjacent on a network data plane but connected by an intermediary lower-layer network element according to another embodiment of the invention. As explained earlier, discovery messages are intended to be sent only to digital nodes. However, when an intermediary optical node, such as optical amplifier, is located between two digital nodes, then the message should be transferred to a receiving digital node via the intermediary optical node.

When a message comes from a customer source, the digital nodes are configured and the cross connections are created to define various time slots, which are allotted to communicate particular traffic. Once time slots are allotted to particular traffic, these slots are effectively designated as “busy” and may be used by other traffic only when the allotted traffic is dropped at a digital node. This “dropped” information should to be sent to a destination digital node so that it can also use the same time slots to receive messages. When a lower-layer optical node is present between two digital nodes, the message is sent to the optical node via a local link and then the message is forwarded to the destination.

A first digital terminal (DT) 401 having an LSC interface sends a local advertisement (e.g., a Link Local Opaque Link State Advertisement (LL-LSA)) to the optical amplifier 402. A Link Local-LSA is a custom OSPF Type-9 Link Local Opaque LSA is used to carry link binding information Label Set (channel availability) and other proprietary information. The flooding scope of this LSA is local to a link.

The first DT 401 sends a local advertisement on optical service channel A, including an LL-LSA, along with link local information. Link Local information is data describing the properties of OCGs, and available time slots.

An optical amplifier (OA) 402 receives the local advertisement and binding information on the local link OSC-A. This local advertisement and binding information is forwarded to a second DT 403, which is its next immediate control neighbor. The second DT 403 in turn may respond with an advertisement of its own to the optical amplifier 402 on the local link. The optical amplifier 402 then transfers the information from the second DT 403 to the first DT 401. As a result of this process, the second DT 403 is discovered as the data-plane-adjacent neighbor of the first DT 401.

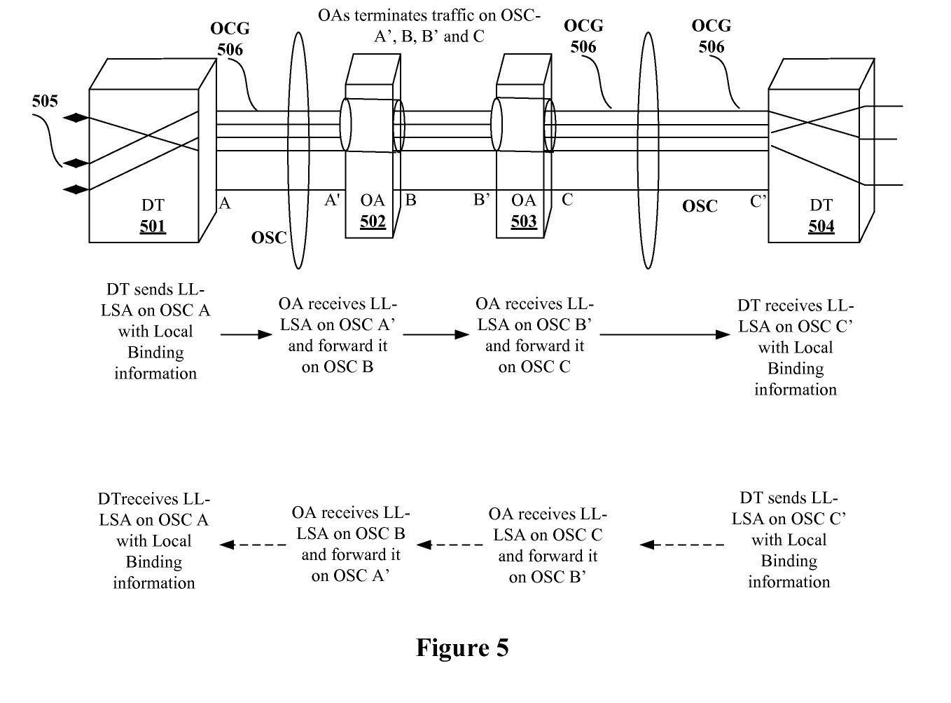

FIG. 5 is an illustration of discovering network elements that are adjacent within a network data plane but separated by multiple intermediary lower-level optical devices according to one embodiment of the invention. In this particular example, a first DT 501 and a second DT 504 are adjacent digital network elements in the data plane but separated by two optical amplifiers. When the digital terminal DT 501, having an LSC interface, transmits a local advertisement, including an LL-LSA, on optical service channel A.

A first optical amplifier 502 receives the local advertisement along with any binding information on optical service channel A′. This advertisement and binding information is forwarded on optical service channel B by the first optical amplifier 502 to a second optical amplifier 503 that receives the data on optical service channel B′. The second optical amplifier 503 forwards the advertisement and binding information on optical service channel C to the next network element, which is the second DT 504. As previously stated, if a chain of lower-layer optical nodes (e.g., optical amplifiers) exists between two digital nodes, a series of local advertisements are transmitted along the chain until the next digital network element with an LSC interface or the data-plane-adjacent neighbor is discovered.

The second DT 504 receives the advertisement and binding information on optical service channel C′. This advertisement and information is processed and the second DT 504 transmits a response with an advertisement of its own. This response message is passed along the chain of lower-layer network elements on the optical service channels unit the first DT 501 receives it. Upon receiving the response message, the first DT 501 is able to discover a network element that is adjacent on the network's data plane but still physically separated by lower-level optical nodes (in this example, optical amplifiers).

In this particular embodiment, the optical amplifiers only have two interfaces to receive or forward the traffic, so it is relatively simple for optical amplifier to pick the right forwarding interface upon knowing on which interface the LL-LSA was received. In effect, the advertisement is passed through the optical amplifier or amplifiers until a digital node is found.

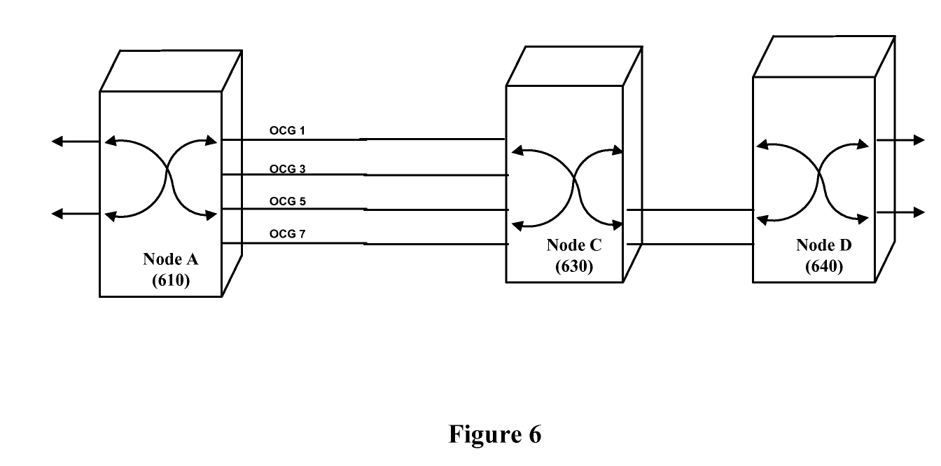

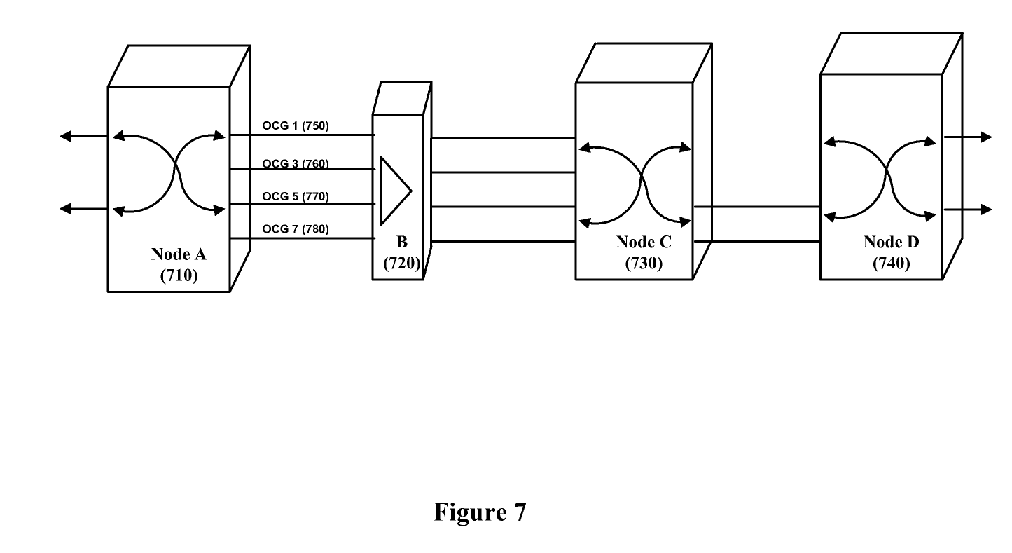

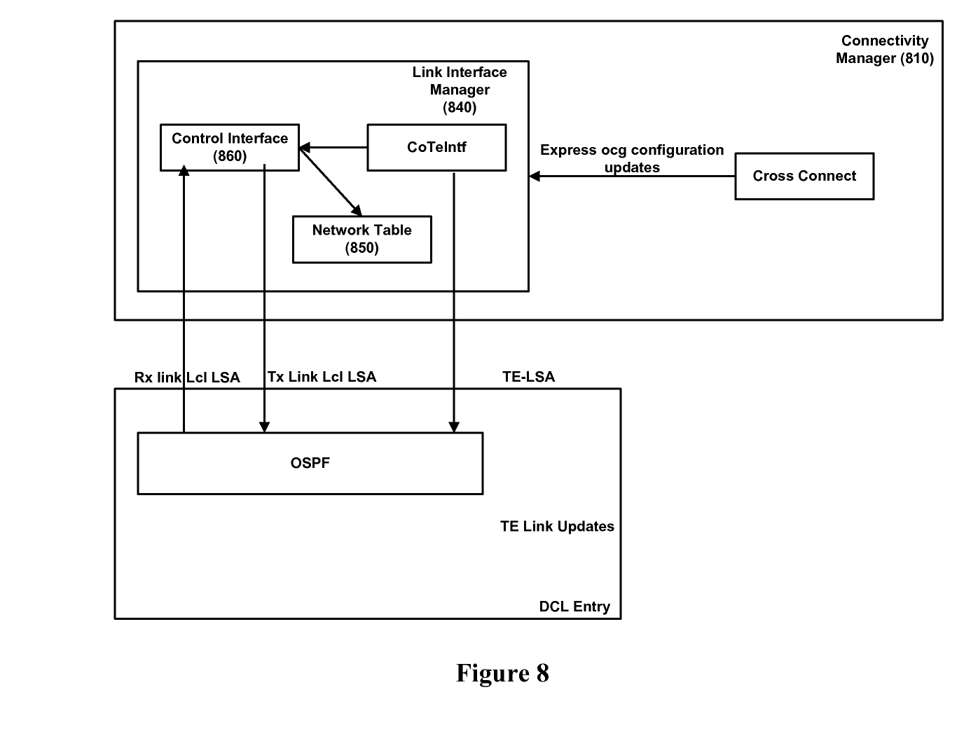

FIG. 6 is an illustration of discovering network elements that are adjacent within a network data plane wherein the adjacent network elements can be separated by intermediary lower-level optical device 620. As mentioned in an previous embodiment the immediate control neighbor is discovered along the OSC path and a multiplexer 610 multiplexes the data and transports the data to the immediate digital node 630 where the data is demultiplexed.

In the electrical domain the data can be processed, updated, or have forward error correction applied in the node before wavelengths are routed. Conversely, in the optical domain the aforementioned processes are bypassed saving bandwidth and time. In other words, in the control plane the data is sent from a multiplexer along a patch to a demultiplexer bypassing any electrical functions in the intermediary nodes.

Normally, the control plane data traffic traverses along the OSC around the intermediary nodes to the immediate digital node, but in this illustration the control plane traverses into the electrical domain along to the immediate digital node 630. This optical express connectivity provides express connection capability on the entire Bandwidth Multiplexing Module (hereinafter, “BMM”) OCG level.

In another embodiment, the overall routing and signaling designs to support OADM are captured. The control interface represents the OSC interface and is a numbered interface on which routing protocol open shortest path first traffic engineering (hereinafter, “OSPF-TE”) is enabled. The traffic engineering interface (hereinafter, “TE”) represents the OCG interface. TE interface is unnumbered and gets advertised through routing protocol OSPF-TE.

The control link represents OSC connectivity between two network elements. The control link is unidirectional and is often referred to as an OSC link. It is distributed to all nodes on the network through OSPF flooding. The TE link represents OCG connectivity between two DTNs. TE links is unidirectional and often referred to as a logical link. Just like control links, TE links are distributed to all nodes on the network throughout OSPF flooding. The SRLG is defines as the set of link (or optical lines) sharing a common physical resource (including fiber links and segments). For instance, a set of links L belongs to the same SRLGs, if established over the same fiber link.

In another embodiment of the invention, FIG. 7 illustrates a sample topology where node A 710 represents a digital transport chassis (hereinafter, “DTC”) A operably connected to node B 720, wherein node B 720 represents a OA, via OCG 1 750, OCG 3 760, OCG 5 770, and OCG 7 780. In the previous embodiments each OCG may carry 10 wavelengths on each fiber allowing a total of 40 wavelengths to traverse the network over OCG 1, 3, 5, and 7. OA is operably connected to node C 730, whereby node C represents an OADM, via OCG 1, 3, 5, and 7. Furthermore, OADM 730 is operable connected to node D 740, whereby node D 740 represents a terminal DTC D, via OCG 5 770 and OCG 7 780.

FIG. 7 further illustrates the 4 OCGs, where OCG 1 750 and OCG 3 760 starts at DTC A 710 and terminates at OADM 730. OCG 5 770 and OCG 7 780 both originate at DTC A 710 pass thru the OA 720 and OADM 730 and terminates at DTC D 740. The nodes are configured to support express OCG binding information updates and notifying the rest of the network of these updates.

At OADM node 730 LL-LSA should be forwarded along the express OCG path by relaying the LSA directly on the other direction. At OA 720 and OADM 730 LL-LSA should be modified to include SRLG information along with OCG binding information for express OCGs. SRLG concept is used for deriving a path, which is disjoint with respect to physical (optical fiber) and logical (optical channel and sub-channels) resources. TE links within the optical fiber share a common risk and hence form a SRLG. The TE-Link LSA changes to flood SRLG information into the network where compute shortest path first changes to store the SRLG information in the database and use this information in diverse route computation.

In a more specific embodiment of the invention, referring to FIG. 7, OCG 1 750 originates at node A 710 and terminates at OADM 730. Local bind information is encoded with the LL-LSA at the node A 710. OA 720 receives the incoming LL-LSA, extracts the bind information of the OCG 1 750, appends SRLG information and encodes information with the LL-LSA and sends LL-LSA to the other side. The interface associated with OCG 1 750 receives the incoming LL-LSA, from OA 720, at the OADM 730 whereby the LSA is updated. At the OADM 730, the bind information is extracted from the OCG 1 and processed to bring up the associated TE Link. Any SRLG information in the bind information is updated on the local interface matching the OCG or band of the OADM. OCG 1 750 is thus terminated at OADM 730.

In yet another specific embodiment, the OCG may be connected from node A 710 and terminate at node D 740. In specific, local bind information of OCG 5 770 is encoded in the LL-LSA associated with the BMM of OCG 5 770 at node A 710. The OA 720 receives the incoming link LL-LSA, extracts the bind information of the OCG 5 770, appends SRLG information and encodes it in LL-LSA sent to other side of OA. The OADM 730 then receives the incoming LL-LSA associated with the BMM of OCG 5 770, extracts bind information of the OCG 5 770, appends SRLG information and encodes it in the LL-LSA being sent to the other side.

The terminal node D 740 associated with the BMM of OCG 5 receives the incoming LL-LSA and extracts bind information from the LL-LSA of the OCG 5 770. The bind information is processed and any SRLG information in the bind information is updated on the local TE interface matching Band or OCG.

FIG. 8 is an illustration of a specific embodiment of the present invention that shows internal interface modules interaction for express connection on the BMM OCG level. A new message is defined for notifying about express OCG configuration updates at a connectivity manager 810. This message contains information related to a BMM OCG port and its remote BMM OCG port which makes an express OCG connection. The connectivity manager 810 upon receiving BMM OCG port configuration updates, updates and notifies a link interface manager 840 by encoding express OCG connection information at chassis level in event. Upon receiving event, the link interface manager creates an event for each BMM in the event. The message includes chassis level express OCG connection information. The network table 850 carries OCG related information in LL-LSA. SRLG information for an express OCG is encoded and appended to Bind 850 while sending LL-LSA.

Furthermore, the LL-LSA has new behavior throughout the network elements. The nodes on receiving LL-LSA simply relay the LSA directly on the other direction. In this embodiment, the nodes will relay the LSA by appending SRLG information along with OCG binding information for the OCGs passing through the OA. For express OCGs the new behavior of appending SRLG information along with OCG binding information at OA nodes will be done at DTC Nodes (transmit and receiver nodes) for express OCGs.

In particular, referring to FIG. 8, Control Interface 860 receives the incoming LL-LSA. For express OCGs it appends SRLG information to the network table information in the LL-LSA, updates the express OCG mate Control Interface with this network table information and originates Link-Local LSA on the mate Control Interface. This mate TE link between end to end DLM OCGs is not created by the network elements until the association between the BMM OCG to BMM OCG is provisioned on the optical express node which is in the path of the TE link.

In contrast, the link-local LSA behavior is different for non-express OCGs. OCG SRLG information in the LL-LSA is configured on the local TE interface matching the Band or OCG. Control Interface 860 receives the incoming LL-LSA. For the OCGs terminating on the node it process the OCG binding information in the LSA and bring up TE and control links. In addition, if any SRLG information exists in the TE binding information it configures the same on the local TE interface matching the Band or OCG.

The foregoing description of the invention has been described for purposes of clarity and understanding. It is not intended to limit the invention to the precise form disclosed. Various modifications may be possible within the scope and equivalence of the appended claims. An optical box may also translate the control messages to the next node whenever required.

We claim:

1. A system of network elements having a method for providing express optical carrier group connectivity between adjacent network elements in a network data plane, the system comprising:
a plurality of digital network elements, communicatively coupled to transmit and receive data;
at least two digital network elements, within the plurality of digital network elements, having lambda switch capable interfaces on which optical data may be multiplexed and demultiplexed into an optical signal;
a first optical carrier group, coupled between the at least two digital network elements, that communicates multiplexed optical traffic and a local advertisement between the at least two digital network elements during a peer discovery process.

2. The system of claim 1 further comprising a lower-layer optical element, coupled between the at least two digital network elements, that receives the local advertisement on a first optical carrier group, updates the local advertisement on the first optical carrier group, and transmits the local advertisement on a second optical carrier group.

3. The system of claim 2 wherein the first optical carrier group and the second optical carrier group are a mate.

4. The system of claim 2 wherein the lower-layer optical element is an optical amplifier or an optical add drop multiplexer.

5. The system of claim 2 wherein the local advertisement is updated by appending share risk link group information and local bind information to the local advertisement before transmitting the local advertisement along to the second optical carrier group throughout the network.

6. The system of claim 1 further comprising a chain of lower-layer optical elements, coupled between the at least two digital network elements, that receives the local advertisement on a first optical carrier group, updates the local advertisement on the first optical carrier group and transmits the local advertisement on a second optical carrier group.

7. The system of claim 6 wherein at least one lower-layer optical element, within the chain of lower-layer optical elements, is an optical add drop multiplexer.

8. The system of claim 1 further comprising a second optical carrier group, coupled between the at least two digital network elements, that communicates multiplexed optical traffic and a local advertisement between the at least two digital network elements during a peer discovery process.

9. A method for providing express optical carrier group connectivity between adjacent network elements in a network data plane, the method comprising:
transmitting a local advertisement on a first optical carrier group from a first digital network element;
communicating the local advertisement on the first optical carrier group to a second digital network element;
processing the local advertisement at the second digital network element; and
transmitting a response advertisement at the second digital network element to the first digital network element on a second optical carrier group.

10. The method of claim 9 further comprising the steps of:
receiving the local advertisement at a lower-layer optical element on the first optical carrier group;
updating the local advertisement at the lower-layer optical element on the first optical carrier group; and
transmitting the local advertisement from the lower-layer optical element along the second optical carrier group to the second digital network element.

11. The method of claim 10 wherein the lower-layer optical element is an optical amplifier.

12. The method of claim 9 wherein the first and second digital network elements are configured to receive local advertisement on matching optical carrier group bandwidth levels.

13. The method of claim 12 wherein the local advertisement is updated by appending share risk link group information and local binding information before transmitting the local advertisement along the second carrier optical group.

14. The method of claim 9 further comprising the step of:
receiving the local advertisement at a chain of lower-layer optical elements on the first optical carrier group;
updating the local advertisement at the chain of lower-layer optical element; and
transmitting the local advertisement from the chain of lower-layer optical element along the second optical carrier group to the second digital network element.

15. The method of claim 9 wherein at least one of lower-layer optical elements within the chain is an optical add drop multiplexer.

16. A computer program product embodied on a computer readable medium for expressly updating optical carrier group information at a network element in the data plane, the computer program product comprising computer instructions for:
transmitting a first message containing a first binding information from a first module within a first network element;
receiving the first message containing the first binding information from the first module at a second module within the first network element;
updating the first message at the second module within the first network element;
communication a second message from the second module the message containing a second binding information; and
transmitting the second message from the second module to a third module within a second network element along an optical carrier group;
wherein the second network element is a lower-layer optical element.

17. The computer program product of claim 16 further comprising computer instructions for:
receiving the second message at a lower-layer optical element on the optical carrier group;
updating the second message at a fourth module within the lower-layer optical element;
transmitting a third message from the lower-layer optical element on the optical carrier group to a third network element;
processing the third message at the third network element; and
transmitting a fourth message from the third network element to the first network element.

18. The computer program product of claim 16 wherein the lower-layer optical element is an optical add drop multiplexer.

19. The computer program product of claim 16 wherein the first message comprises a link local link state advertisement.

20. The computer program product of claim 19 wherein the link local link state advertisement comprises local binding information and shared risk link group that are provided to the third network element.
